(19) United States
(12) Patent Application Publication
(10) Pub. No.: US 2008/0235734 A1
(43) Pub. Date: Sep. 25, 2008

(54) Optimally Selecting Tv Programs for Recording and Viewing

(75) Inventor: Wilhelmus F.J. Verhaegh, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/067,852

(22) PCT Filed: Sep. 22, 2006
(86) PCT No.: PCT/IB2006/053460

§ 371 Date: Mar. 24, 2008

Related U.S. Application Data
(60) Provisional application No. 60/720,090, filed on Sep. 23, 2005.

(51) Int. Cl. G06F 3/00

(52) U.S. Cl. 725/46

(57) ABSTRACT

A system (400), apparatus (300), and method (200) are provided to simultaneously select TV programs for recording and watching during a certain time period [b, e] having a beginning time b and an ending time e. For each TV program a value is provided for receiving and recording and an additional value for watching. The values represent the preferences of a viewer. A dynamic programming approach is provided that solves the selection and viewing problem to optimality (guaranteed). The key idea behind the DP approach is the definition of the states, which represent all relevant information of previous steps needed to be able to judge a following step. A state definition includes time points at which the tuners are available after having received a program, and the time point at which the viewer is available again for watching the next program. Using this state definition, the present invention recursively expresses and calculates the effect of choosing a certain program for recording and/or watching. Although the run time of the approach grows exponentially in the number of tuners and the number of TV programs considered, it is reasonable in a practical situation. Alternative embodiments are provided to reduce the run time considerably, without sacrificing the quality of the end result.

The present invention relates to the use of dynamic programming for selecting TV programs from a previously specified set of preferred programs, for simultaneous recording and viewing during a given time period.

With the ever increasing number of available television channels, either through terrestrial connections, satellite, or cable, the task for a viewer of selecting TV programs to watch and record is becoming too big to handle manually. With the advent of digital television, the number of channels, hence the number of options, to choose is becoming even greater. Therefore, viewers can no longer overview all available contents, and it becomes more likely that a viewer will miss TV programs that he or she would find very interesting.

Because of the high number of TV programs available each week, printed program guides are no longer a viable option, as they would simply become too extensive to use. Electronic program guides (EPGs) form a solution to this problem by presenting the available TV programs for a number of channels on a TV screen. However, only a limited amount of information can be shown, e.g., the number of channels and the length of the time interval of the portion shown on the screen are very limited, because of the poor resolution of a TV screen for this kind of information. And, even if the resolution were high enough, simply programming all available TV contents would overwhelm the average viewer.

In order to alleviate the viewer's problem of what TV programs to select and when to watch them, i.e., the problem of developing a viewer-specific viewing schedule, EPGs offer an option of searching (filtering) by keyword(s). In this way EPGs reduce the number of TV programs to be screened and selected by the viewer to a tractable number. Another way for the viewer to cull a plurality of TV programs that are uninteresting to the viewer is through the use of recommender systems based on artificial intelligence (AI) technology. These AI recommender systems maintain a preference profile of the viewer, indicating what the viewer likes and dislikes, and employ this profile to score each newly offered program as to what extent the viewer will like the newly offered TV program. Then, the programs scoring in excess of a pre-determined viewer-specific tolerance are highlighted in an EPG or the viewer is provided a list of these programs. A problem with these solutions, however, is that they do not take into account whether or not programs overlap in time, so it remains for the viewer to compile a viewer-specific schedule of top-scoring TV programs to watch during an evening for example. In other words, whereas filters and recommenders come up with a list of individual programs, such a list is an incomplete solution to a viewer's problem of creating a schedule of programs to watch.

A similar situation exists for recording TV programs.

A solution is needed that, for a given time period, combines the two steps into one, i.e., selection of programs for watching and recording, simultaneously, for which a limited number of tuners is given, that must be shared.

The system, apparatus, and method of the present invention provide a way to create personalized TV viewing evenings, by compiling a sequence of consecutive TV programs for watching and recording, simultaneously. Before compiling such a sequence, a set of viewer-preferred TV programs appearing in a broadcast schedule must be selected.

When time-shifting is introduced (recording programs to be watched later), a plurality of tuners is available, and a limit on the total time of programs to be watched is given, the present invention provides a dynamic programming approach that solves the time-shifting program selection problem to optimality. Experiments indicate that an implementation that includes time-shifting runs in reasonable time on practical problem instances. Furthermore, alternative embodiments are provided to reduce the run time, albeit at the cost of losing the guarantee of finding an optimal solution.

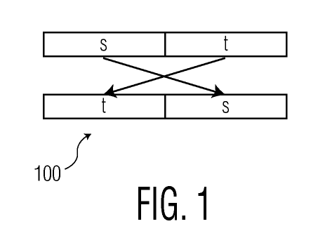

FIG. 1 illustrates swapping directly succeeding programs s and t;

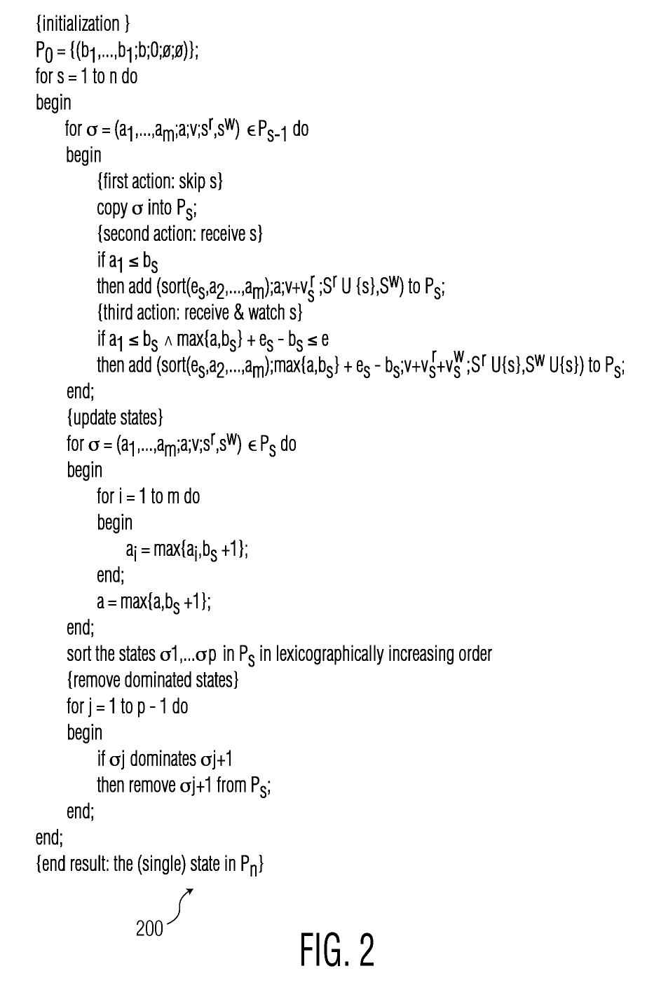

FIG. 2 illustrates a pseudo code for a dynamic programming approach;

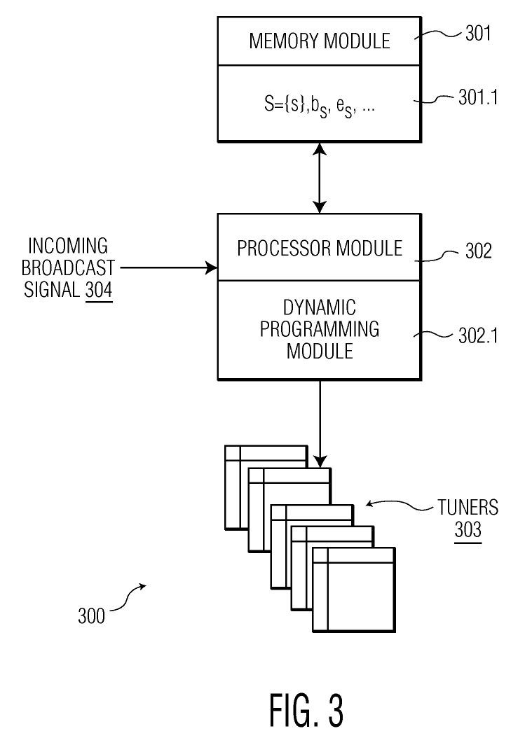

FIG. 3 illustrates an apparatus for performing the method according to the present invention; and

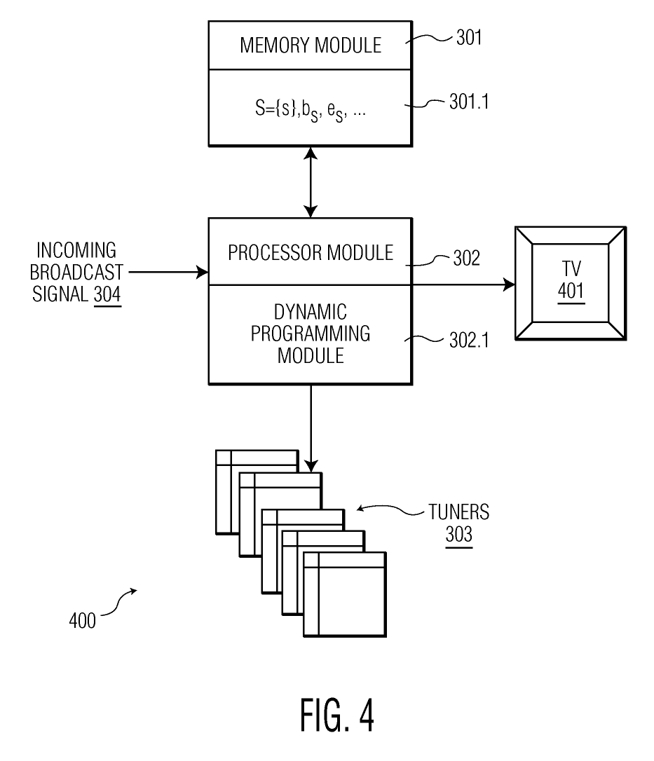

FIG. 4 illustrates a system for receiving, recording and displaying a set of TV programs according to the present invention.

The system, apparatus, and method of the present invention provide a way of determining an optimal TV experience to a viewer for a given time interval, the experience comprising watching as well as recording preferred TV programs using a plurality of tuners.

Time-Shifted Viewing

The viewer's scheduling problem consists of two aspects. First is selection of the programs to receive (which will be recorded). Second, from this first selection it must be decided which programs to watch during a given interval (e.g., that evening) and at what time.

It is assumed that a certain value per program is given for receiving it, and an additional value is given if it is also selected for watching. For instance, a sports program is assigned a certain value for being received (and recorded), and an additional value if it can be watched during the evening of the broadcast.

Consider a setting in which only complete programs are received using a plurality of tuners.

Time-Shifted Program Selection Problem (TSSP) Embodiment

Given is a set S of TV programs that a viewer has specified a preference for watching, for each program s, a begin time bₛ and an end time eₛ, and a number m>1 tuners. Furthermore, for each program s a value vₛ^{r} is given for receiving it, and an additional value vₛ^{w} is given for watching it. Finally, a begin time b and an end time e are given, indicating the interval [b, e] during which the viewer wants to watch programs.

The system, apparatus, and method of the present invention determine a subset S^{r}⊂S of programs to be received (and recorded), and a subset S^{w}⊂S^{r} of programs that are going to be watched, such that at all times at most m programs must be received, i.e., for all times x we have

|{s∈S^{r}|bₛ≦x<eₛ}|≦m,

such that the set S^{w} of programs selected for viewing can be scheduled in the time interval [b, e], and such that the total value of this solution, given by

$${\sum }_{s ∈ {S}^{r}} {v}_{s}^{r} + {\sum }_{s ∈ {S}^{w}} {v}_{s}^{w}$$

is maximized.

The constraint that the set S^{w} selected for watching can be scheduled in the time interval [b, e] means that we also have to determine for each of the programs s in this set, a time wₛ at which its viewing starts, such that for all s∈S^{w},

wₛ≧bₛ

wₛ≧b

wₛ+eₛ−bₛ<eₛ

and such that for all s,t∈S^{w},s≠t,

wₛ≧wₜ+ₜ−bₜVwₜ≧wₛ+ₛ−bₛ.

Note that scheduling the programs selected for viewing may introduce gaps in the schedule. Such a gap will, for instance, be introduced if it is better to wait some time for a program to be broadcast if it has a very high value.

The above problem is typically solved for a limited time interval, e.g., an evening. The programs in S^{w} can be watched on the same evening, while the programs in S^{r}\S^{w} can be watched on another occasion. For example, they can be used if programs in S^{w} turn out to be disappointing, or they can be used on other days when there are no good programs being broadcast.

Scheduling Programs for Viewing

Theorem. Without loss of feasibility, a set S^{w} of programs selected for watching can be scheduled in a time interval [b, e] in the order of increasing begin time.

Proof. Suppose there exists a feasible schedule, given by the start times wₛ for all s∈S^{w} and suppose there are two programs s, t, with s being scheduled directly before t, but with t being available before s, i.e., bₜ<bₛ. Then, swapping s and t also gives a feasible schedule, which can be seen as follows.

Consider the schedule w′ which is given by the same start times for all programs except for programs s and t, which are given by

w′ₜ=wₛ

w′ₛ=w′ₜ+eₜ−bₜ.

These programs directly succeed one another. See FIG. 1 for a visualization of this swap. This swap only affects programs s and t and not the other programs, so that only s and t must be checked for meeting the constraints. To this end, the following are derived:

w′ₜ=wₛ≧b

w′ₜ=wₛ≧bₛ>bₜ

w′ₜ+eₜ−bₜ≦wₜ+eₜ−bₜ≦e

w′ₛ≧wₛ≧b

w′ₛ≧wₛ≧bₛ

w′ₛ+eₛ−bₛ=wₛ+eₜ−bₜ+eₛ−bₛ≦wₜ+eₜ−bₜ≦e.

Therefore, scheduling the programs for viewing can be done in the order of increasing begin time. Furthermore, assigning tuners to the programs to be received corresponds to coloring an interval graph, which can also be done in the order of increasing begin time by means of the so-called left-edge coloring algorithm. This allows application of a dynamic programming approach, in which the programs are iteratively considered in the order of increasing begin time, and determination for each program whether to skip, receive, or receive and watch it. For the remainder of this disclosure, assume the programs to be numbered s=1, 2 . . . n, with bₛ<bₛ₊₁ for all s=1 . . . , n−1.

A Dynamic Programming Approach

A preferred embodiment is a dynamic programming approach in which the TV programs are considered in the order of increasing begin time. The state space chosen is such that when considering a certain program s, all the relevant information is available concerning previous decisions in order to determine the effect of skipping, receiving, or receiving and watching s (possibly time-shifted).

Therefore, in a preferred embodiment a state is given by the time onwards from which each of the tuners is (again) available for receiving the next program, plus the time onwards from which the next program can be scheduled for viewing. Given this information, it can be determined whether to skip, receive, or receive and watch the next program s under consideration, and what the effect is of these choices. Without loss of generality, the times for the tuners are sorted in non-decreasing order, as all tuners are identical.

In addition to the above parameters to keep track of the state, for each state the value is maintained of the already selected programs for reception and viewing. Furthermore, for each state the sets S^{r} and S^{w} are stored of programs selected for reception and viewing, respectively, so afterwards we can simply read out what the solution is.

More formally, a state is given by an (m+4)-tuple (a₁ . . . , aₘ; a; v; S^{r}.S^{w}), where a₁ . . . , aₘ indicate the times when each tuner is again available, with aᵢ≦aᵢ₊₁ for all i=1 . . . , m−1, a indicates the time when the viewer is again ready to watch the next program, and v is the total value of programs selected up to now.

The begin state for dynamic programming is given by aᵢ=b₁ for all i=1 . . . , m, i.e., the tuners are available from the first beginning of any program, a=b, i.e., the viewer can start watching from time b onwards, a value v=0, and sets S^{r}=S^{w}=φ. The set of possible states is hence initialized by P₀={(b₁ . . . , b₁;b; 0;φ;φ}}.

Next, given the set of possible states Pₛ₋₁ at the beginning of iteration s=1 . . . , n of the dynamic programming approach, we can calculate the set of possible states P_{S} at the end of this iteration as follows. For each state (a₁ . . . , aₘ; a; v; S^{r}.S^{w}), ∈Pₛ₋₁, we can take (at most) three possible actions for the program s under consideration:
1. The first action is to simply skip program s. This does not change the state at all, so we get an identical state (a₁ . . . , aₘ;a;v;S^{r}.S^{w}), in Pₛ.
2. The second action is to receive program s, which can be done if and only if there is a tuner available at time bₛ. As the tuner availability times are sorted, this can be checked by checking whether a₁≦bₛ holds. If so, this first tuner can be used for receiving the program, and this tuner will again be available at the end time eₛ. So, a new state is obtained (eₛ, a₂ . . . , aₘ; a; v+vₛ^{r}; S^{r}∪{s},S^{w}), in Pₛ, where the availability times eₛ, a₂ . . . , aₘ are next sorted again.
3. The third action is to select program s for reception and viewing (possibly time-shifted), which is possible if and only if there is a tuner available at time bₛ, i.e., a₁≦bₛ, and there is still time to watch program s. For the latter, the viewer is again available from time a onwards, and the program is available from time bₛ onwards, so watching this program can start at time wₛ=max {a, bₛ}. Note that if a>bₛ, the program will be time-shifted, i.e., recorded. Watching programs should be finished by time e, so max {a, bₛ}+eₛ−bₛ≦e has to hold. If these two conditions are met, program s can be selected for watching. Again, the first tuner is used for receiving the program, so it is available again at time eₛ. Furthermore, the program is scheduled for watching at time wₛ=max{a, bₛ}, so the viewer can continue watching from time wₛ+eₛ−bₛ onwards. So, this gives a new state

(ₛ,a₂, . . . aₘ;wₛ+ₛ−bₛ;v+vₛ^{r}+vₛ^{w},S^{r}∪{s},S^{w}∪{s})in Pₛ,

where again the availability times eₛ, a₂, . . . , aₘ are resorted.

Next, the set Pₛ of states may be pruned, as some states may dominate other states. Before doing so, however, the states in Pₛ are updated as follows. Because the next program begins at time bₛ₊₁ (where we may define bₙ₊₁=∞) and the following ones do not begin earlier, a tuner availability time aᵢ<bₛ₊₁ might as well be replaced by an availability time aᵢ=bₛ₊₁. Similarly, the time a at which the viewer is again available for watching may as well be replaced by bₛ₊₁ if bₛ₊₁>a. Note that in the latter case the watching schedule of the corresponding state will have a gap.

After the updating step, dominated states are removed. A state

σ=(a₁ . . . aₘ;a;v;S^{r},S^{w})∈Pₛ

is said to dominate another state

σ′=(a′₁, . . . , a′ₘ;a′;v′;S′^{r},S′^{w})∈Pₛ

if and only if the next three conditions hold:

aᵢ≦a′ⱼ for all i=1, . . . , m

a≦a′

v≧v′.

So, the availability of the tuners and the viewer in state σ are no later than in state σ′, whereas the value of σ is at least as good as the value of σ′. In this situation, σ′ can be removed from Pₛ without loss of optimality. This results in a smaller set of states, and hence in a shorter run time of the algorithm.

To remove all dominated states, a check must be performed for each pair of states, which takes a number of steps that are quadratic in the number of states. As this will be too time consuming in practice, in a preferred embodiment a less complete check is performed by first sorting the states, and next comparing each pair of successive states. This results in a good trade-off between the run time required for domination checks and the run time saved by reducing the state space. A pseudo code for the resulting dynamic programming approach is given in FIG. 2.

Run Time Improvements

Three alternative embodiments reduce the run time, at the cost of losing the guarantee of finding an optimal solution.

1. Reducing the State Space by Making the Time Granularity Larger

Key in the dynamic programming approach of the present invention is that the state space can be reduced after each step by removing dominated states, and that in this way the state space can be kept reasonably small. An important factor in this is the time granularity of the problem instance at hand. If the time granularity is relatively large, compared to the total time span, then the number of possible availability times is quite small. For instance, if all programs begin and end at multiples of half an hour, and the earliest time point is 18:00 and the latest one is 23:00, then each availability time (of each tuner and of the viewer) can assume only 11 values. If there are two tuners, then there are 66 possible pairs (a₁, a₂) of tuner availability times, so the state space contains at most 66*11=726 states, regardless of the number of programs. If, however, the time grid is one minute, then the number of possible availability times is much larger, and hence the state space can become very large.

A way to prevent the state space from becoming very large is by artificially making the time granularity larger. For instance, all times may be rounded to multiples of five minutes. In a preferred embodiment, for the availability time of the viewer, this is done by only rounding upwards. Then, the amount of programs selected for watching with rounded times can certainly be watched if times are not rounded. In other words, the found solution is guaranteed to be feasible, but we may lose optimality. Rounding the availability time to the nearest (not necessarily higher) multiple of the time grid may also be done, but then the end time e may exceed by the eventual solution.

In a preferred embodiment, the availability times aᵢ of the tuners i=1 . . . , m, are only rounded upwards. A drawback of this approach, however, is that two programs that directly succeed each other on a channel may not be selected together. For instance, if the first program is selected, and the corresponding tuner is available again from the end time of this program, then by rounding up this availability time it may be concluded that it is not possible to also receive the next program with this same tuner. If the begin and end times of the programs are such that there is a gap between the end of one program and the beginning of the next one on the same channel (for instance because of commercials in between), then this effect of rounding need not occur. Furthermore, if it is not an issue that the beginning of a program is missed, one may resolve the problem caused by rounding times upwards by simply increasing all begin times by a certain amount.

2. Filtering Programs

An alternative preferred embodiment reduces the run time of the dynamic programming approach by pruning the set of programs before solving the instance. To this end, a lower bound pₘᵢₙ is set on the preference density of a program, and all programs with value vₛ<pₘᵢₙ(eₛ−bₛ) are removed. Key in this pre-filtering step is that a sufficient number of uninteresting programs are removed, but still a sufficient number of interesting programs is retained to choose from.

3. A Two-Step Approach

A further alternative embodiment reduces the run time by applying a two-step approach. To this end, the dynamic programming problem is first solved where the only options per program are to either skip it or to select it for watching. Therefore, the option to only receive (and not watch) a program is not considered in this alternative embodiment. This embodiment reduces the growth of the state space.

Next, when an optimal set S^{w} of programs is selected for watching, it is then determined which programs can additionally be received (for recording). So, keeping S^{w} fixed, an optimal set S^{g} of programs is determined that is to be received in addition to S^{w}.

1. A method for receiving and watching preferred TV programs in a given time period [b,e] beginning at time b and ending at time e, comprising the steps of:
specifying a set S of a number n≧1 of preferred TV programs numbered s=1 . . . , n each having a begin time bₛ, an end time eₛ, a received value vₛ^{r} and a watched value vₛ^{w} (301.1);
providing a plurality m≧1 of tuners (303) to receive (and record) a program s of S;
applying a dynamic programming approach (302.1) to select a subset S^{r}⊂S of the specified set S of programs to receive and record, and to select a subset S^{w}⊂S^{r} of programs to also watch, such that the programs in St can be received with the plurality of tuners without conflicts, the programs in S^{w} can be watched within the time interval [b, e), and the total value of the subsets is maximized.

2. The method of claim 1, wherein the applying step further comprises the steps of:
performing one of the actions selected from the group consisting of skip and receive and watch with respect to each program s of S; and
determining an optimal set of shows to be received and recorded in addition.

3. The method of claim 1, wherein the applying step further comprises the step of performing one of the actions selected from the group consisting of skip, receive, and receive and watch with respect to each program s of S.

4. The method of claim 1, wherein:
the specifying step further comprises the step of ordering the set S consisting of a number n≧1 of preferred TV programs s=1 . . . , n−1 by begin time bₛ of program s such that bₛ≦bₛ₊₁ for all s=1 . . . , n; and
the applying step further comprises the step of considering each program in the order of increasing begin time.

5. The method of claim 4, wherein the applying step further comprises the step of performing one of the actions selected from the group consisting of skip, receive, and receive and watch with respect to each program s of S.

6. The method of claim 5, wherein the applying step further comprises the step of representing a dynamic programming state to include the time subsequent to which each of the m≧1 tuners is available to receive the next show and a time the next show can be scheduled for viewing.

7. The method of claim 6, wherein the applying step further comprises the steps of:
determining if a state is dominated by another state using a pre-determined decision criterion; and
removing a state that is determined to be dominated by another state.

8. The method of claim 7, wherein the determining step is performed between each pair of successive states only.

9. The method of claim 8, wherein all begin and end times are rounded to multiples of a pre-specified amount of time.

10. The method of claim 9, wherein an initial pre-filtering step is performed first to remove all programs s having a preference value vₛ that is less than a pre-determined minimum preference density pₘᵢₙ times the length eₛ−bₛ of the program.

11. An apparatus (300) for reception and delivery of preferred TV programs (304) during a given time period [b,e] beginning at time b and ending at time e, comprising:
a memory module (301) containing a set S of a number n≧1 of preferred TV programs numbered s=1 . . . , n each having a begin time bₛ, an end time eₛ, a received value vₛ^{r} and a watched value vₛ^{w};
a number m≧1 of tuners (303) to receive (and record) a program s of S;
a processor module (302) configured to execute a dynamic programming module that accesses the memory to select a subset S^{r}⊂S of the specified set S of programs to receive and record, and to select a subset S^{w}⊂S^{r} of programs to also watch, such that the programs in S^{v} can be received with the plurality of tuners without conflicts, the programs in S^{w} can be watched within the time interval [b, e], and the total value of the subsets is maximized.

12. An apparatus (300) for reception and delivery of preferred TV programs (304) during a given time period [b,e) beginning at time b and ending at time e, comprising:
a memory module (301) containing data describing a set S of a number n≧1 of preferred TV programs numbered s=1 . . . , n each having a begin time bₛ, an end time eₛ, a received value vₛ^{r} and a watched value vₛ^{w};
a plurality m≧1 of tuners (303) to receive (and record) a program s of S;
a processor module (302) configured to execute the method of claim 10 using the data describing set S in the memory and the plurality of tuners.

13. A system (400) for scheduling a TV viewing session of programs preferred by a viewer, comprising:
a TV set (401) for viewing programs;
an apparatus (300) according to claim 12 for selecting and receiving a viewer's preferred TV programs and displaying on the TV (400) at least a part of the received programs during a predetermined time span [b,e] having a beginning time b and an ending time e.

14. A computer program (200) stored in a memory (301), comprising an executable module (200) to perform the method of claim 1 and a data module including a set S as input of the method of claim 1 comprising a number n≧1 of preferred TV programs numbered s=1 . . . , n each having a begin time bₛ, an end time eₛ, a received value vₛ^{r} and a watched value vₛ^{w}.
